(19) United States
(12) Patent Application Publication
(10) Pub. No.: US 2011/0125674 A1
(43) Pub. Date: May 26, 2011

(54) METHOD AND DEVICE FOR PREVENTING THE DROPPING OF CHANGE AT FAST FOOD RESTAURANT DRIVE-THROUGH WINDOWS

(76) Inventor: Scott A. Masters, Solana Beach, CA (US)

(21) Appl. No.: 12/622,439

(22) Filed: Nov. 20, 2009

(51) Int. Cl. G06Q 90/00; B42D 15/00; B65D 27/00

(52) U.S. Cl. 705/500; 283/56; 229/68.1

(57) ABSTRACT

A device and method for preventing the dropping of money while change is being handed through a drive-through window from a cashier to a customer in an automobile. The cashier places the change is a specially designed envelope. The envelope has a pocket for holding the change and at least one third party ad is printed on the envelope. The cashier passes the envelope through the drive-through window. The customer grabs the envelope from the cashier and then removes the change from the envelope inside the automobile's interior. In a preferred embodiment, the envelope has shape characteristics and a printed image that relate to the business identity of the third party who paid for the ad. Also in a preferred embodiment, the fee paid by the third party ad purchaser surpasses the cost of the envelope to the fast food restaurant.

The present invention relates to fast food restaurants, and in particular, to change transfer at fast food restaurant drive-through windows.

### BACKGROUND OF THE INVENTION

Fast Food Restaurants

Fast food restaurants, also sometimes known as a quick service restaurants or QSRs, are extremely popular and have become an integral part of the modern American culture. A fast food restaurant is a specific type of restaurant characterized both by its fast food cuisine and by minimal table service. Food served in fast food restaurants typically is cooked in bulk in advance and kept hot; is finished and packaged to order; and is usually available ready to take away, though seating may be provided. Fast food restaurants are usually part of a restaurant chain or franchise operation, which provisions standardized ingredients and/or partially prepared foods and supplies to each restaurant through controlled supply channels. McDonald's® and Burger King® are both examples of very popular fast food restaurants in the United States.

It is common for a fast food restaurant to include a drive-through service at the restaurant. A drive-through, or drive-thru, is a type of service provided by the restaurant that allows customers to purchase products without leaving their cars. The format was first pioneered in the United States in the 1940s but has since spread to other countries.

At the drive-through service, a customer generally places his order by using an outdoor microphone and listens to the restaurant worker reply through an outdoor speaker. The cars create a line and move in one direction and the food is generally brought to the window by a server, and the customer can remain in the parked car to eat.

Dropped Change Phenomena at Fast Food Restaurants

There is a common ongoing problem at fast food restaurants with drive-through service. The driver receives his food and then gives payment to a cashier positioned at the drive-through window of the restaurant. Typically the driver pays with paper bills and the cashier provides change to the driver consisting of a possible combination of bills and coins. When the cashier hands change back to the driver the driver is seated in the driver's seat of the car. It can be awkward positioning and the cashier and driver often have difficulty successfully transferring the change. For example, the driver may have to undo his seatbelt to reach the cashier. The driver will then hold his hands outward, palms facing upward in a cupping manner as the cashier attempts to slide the change into his hands. In a common condition of inclement weather the driver may actually crush the bills while trying to quickly grab the money so that it does not fly away in the wind. Oftentimes the change is dropped to the ground during the transfer. It is usually impractical or even unsafe for the driver or the cashier to try to pick up the change from the ground. Therefore, typically, the change is just left sitting on the ground. In an effort to expedite customers leaving the window, the common restaurant practice is to just give the driver the amount of change that has fallen to make up for the dropped change. This is, however, often difficult to accomplish quickly because a determination has to be made as to the amount of the dropped change. The driver has to communicate to the cashier the amount of change he successfully received and the amount that is still owed. If there is a language barrier this could add to the difficulty. Then, after the determination has been made as to the amount owed, the cashier can attempt once again to hand to the driver the change owed.

Sometimes when there is a lull in business the cashier may step out below the window and try to look for any fallen change. Often, however, the change has rolled away or bills have blown away and cannot be found. Also, since this phenomenon is so well-known, subsequent drivers or passersby will often look for dropped change underneath the drive-through windows before a new car can pull up to the window. Once they find the dropped change the subsequent drivers or passersby will keep it for themselves. In most cases the restaurant just absorbs this loss.

Cover Stock

Cover stock is a paper stock that is thicker and more durable than normal writing or printing paper, but thinner and more flexible than other forms of paperboard.

What is needed is a method and device for preventing the dropping of change at drive-through windows at fast food restaurants.

### BRIEF DESCRIPTION OF THE DRAWINGS

FIGS. 1-5 show a preferred method for making a preferred embodiment of the present invention.

FIG. 6 shows a method of utilizing a preferred embodiment of the present invention.

FIG. 7 shows another preferred embodiment of the present invention.

FIG. 8 shows another preferred embodiment of the present invention.

FIG. 9 shows another preferred embodiment of the present invention.

### SUMMARY OF THE INVENTION

The present invention provides a device and method for preventing the dropping of money while change is being handed through a drive-through window from a cashier to a customer in an automobile. The cashier places the change is a specially designed envelope. The envelope has a pocket for holding the change and at least one third party ad is printed on the envelope. The cashier passes the envelope through the drive-through window. The customer grabs the envelope from the cashier and then removes the change from the envelope inside the automobile's interior. In a preferred embodiment, the envelope has shape characteristics and a printed image that relate to the business identity of the third party who paid for the ad. Also in a preferred embodiment, the fee paid by the third party ad purchaser surpasses the cost of the envelope to the fast food restaurant.

### DETAILED DESCRIPTION OF THE PREFERRED EMBODIMENTS

Preferred Envelopes

In the preferred embodiment a cashier places change owed to the customer in specially designed envelope 10 (FIGS. 3-5). Please note that envelope 10 may also correctly be referred to as being a folder, a paper folder or a paper cache. The envelope not only protects the change so that it is not easily dropped during transfer, but the envelope also provides an extremely strong advertising message to the customer. The envelope has shape characteristics, image characteristics and wording that all relate to the identity of a third party ad purchaser.

Making a Preferred Envelope

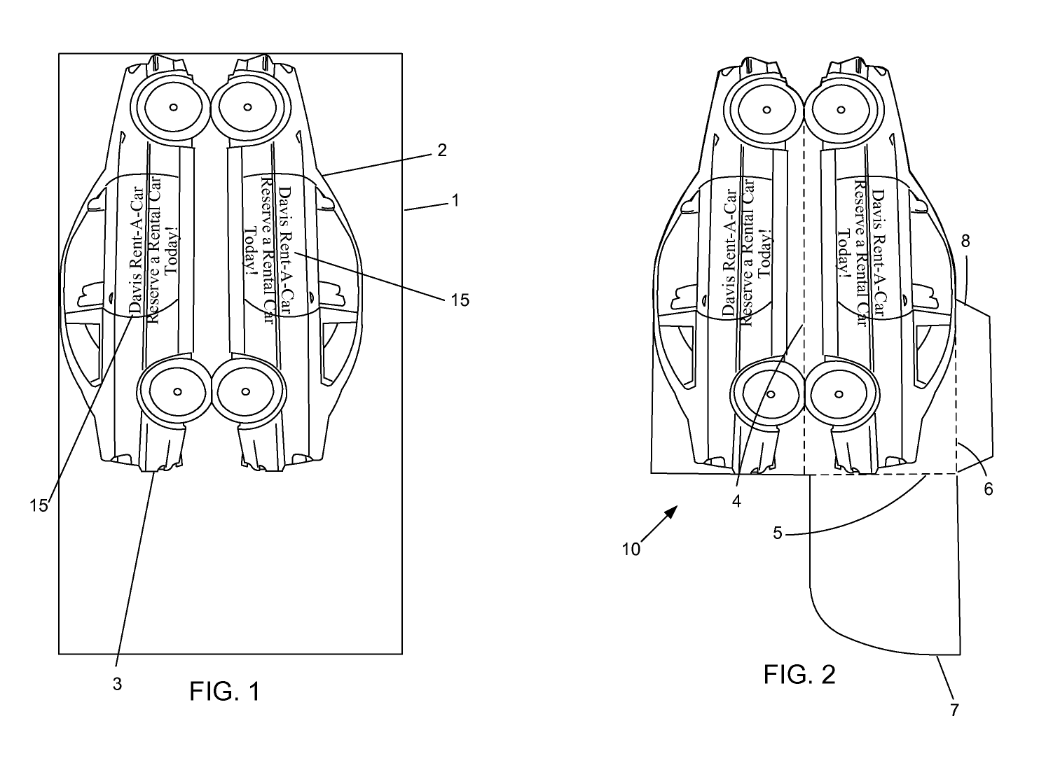

In FIG. 1 an image of car 2 and its reflection 3 are printed onto cover stock 1 as shown. Advertisement message 15 has been printed over the image of car 2 and its reflection 3.

In FIG. 2 envelope 10 has been cut out of cover stock 1 and appears as shown. Cover stock 1 has been cut so that a significant portion of the cut follows the outline of car 2 and reflection 3. Flaps 7 and 8 have also been cut out of cover stock 1. Envelope 10 has been creased along lines 4, 5 and 6.

In FIG. 3 envelope 10 has been turned over so that the image of car 2 and its reflection 3 are facing downward. Flap 7 has been folded along crease 5 and flap 8 has been folded along crease 6 (see FIG. 2). Flap 7 has been glued to flap 8 (not shown in FIG. 3) to form pocket 11. Pocket 11 is of sufficient size so that it allows for the convenient storage of money and receipts. For example, FIG. 3 shows five dollar bill 12 and coins 13 stored in pocket 11. Advertisement message 17 has been printed onto interior portion 18 and advertisement message 18 has been printed onto pocket 11.

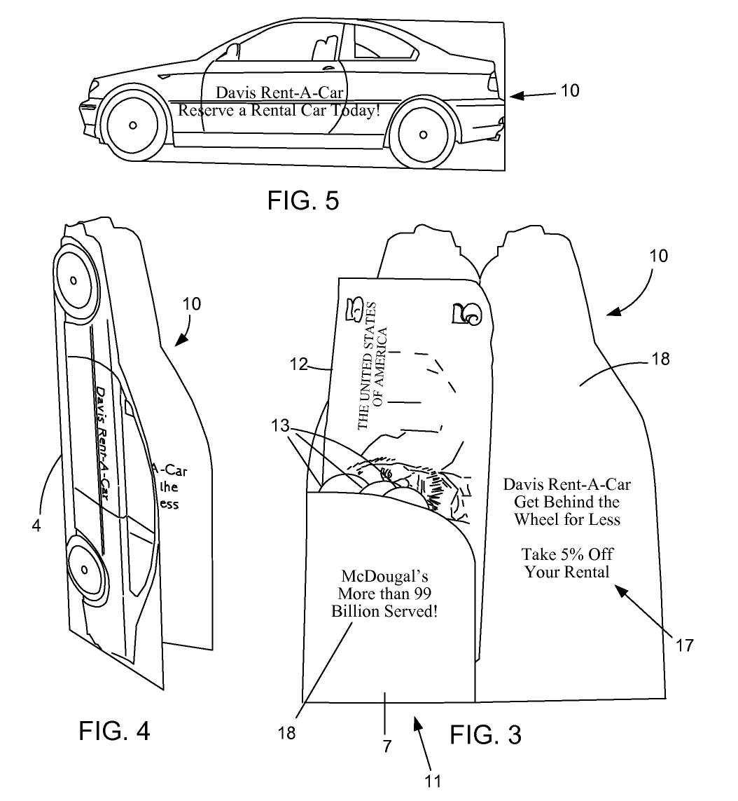

FIG. 4 shows a perspective view of envelope 10 illustrating clearly how envelope 10 is foldable along crease 4.

FIG. 5 shows a top view of envelope 10 as it appears when laid flat on a table.

Utilization of a Preferred Embodiment

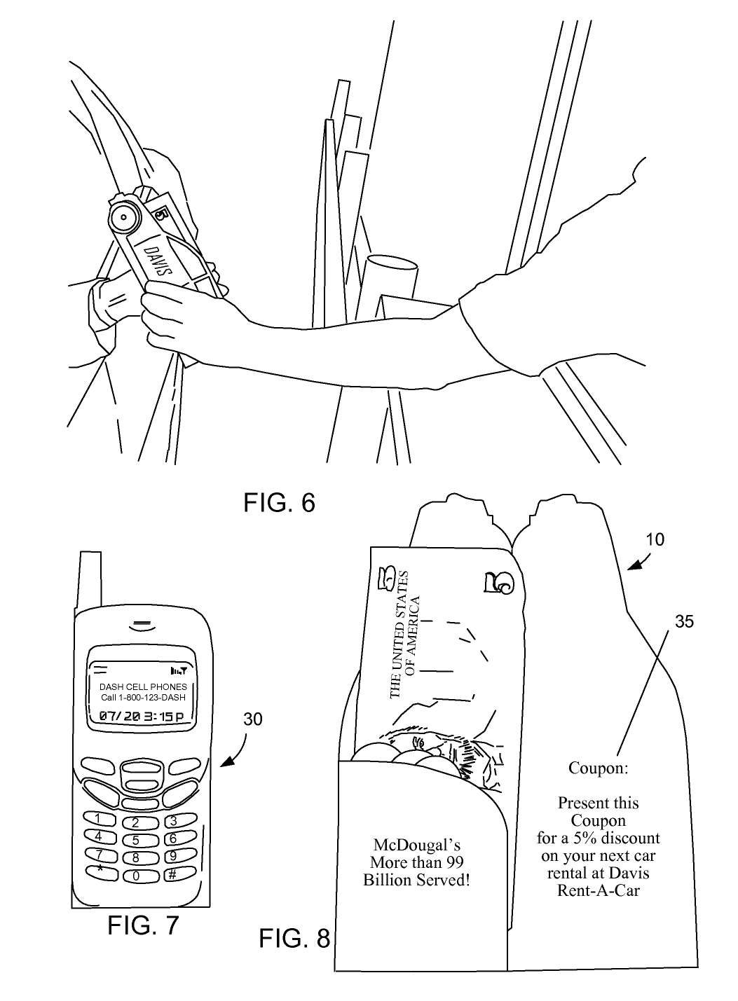

FIG. 6 illustrates the operation of a preferred embodiment of the present invention. In FIG. 6 the cashier is positioned at the drive-through window. The cashier is in the process of handing change to the driver who is sitting in the front seat of his car. The cashier has placed the change inside pocket 11 of envelope 10. Therefore, the change is properly contained and does not blow away or drop to the ground. Also inside pocket 11 is the receipt from the transaction.

Advertisement

In the preferred embodiment of the present invention advertisers have paid the restaurant a fee to advertise their business on envelope 10. The fee that is charged to the advertisers preferably exceeds the cost of envelope 10. Therefore, the restaurant makes a profit by utilization of the present invention.

As shown in FIGS. 1-5, there are multiple areas on envelope 10 to print advertising messages. For example, consider a situation in which a hypothetical international fast-food restaurant McDougal's utilizes envelope 10 to hand change back to customers at their drive-through windows. In FIGS. 1-5, McDougal's has sold advertisement to Davis Rent-A-Car at 10 cents per envelope. The cost of producing one envelope is approximately 6 cents. This results in a profit to McDougal's of 4 cents.

In the McDougal's example mentioned above, advertisement message 15 is printed on the outside of envelope 10. Also, Davis advertisement message 17 is printed on interior portion 18 of envelope 10. In the embodiment shown in FIGS. 1-5, McDougal's has placed their own advertisement message 18 on pocket 11.

Modifications

Although it was described above how McDougal's placed their own advertisement on pocket 11, McDougal's can also sell further advertising to Davis and place it on pocket 11. Or McDougal's can place advertisement from a variety of companies on envelope 10 at various locations and charge each company a separate fee.

Advertiser's Identity Matches Shape of Envelope

It should be noted that in the preferred embodiment of the present invention, the identity of the advertiser matches the shape of envelope 10. For example, envelope 10 is shaped like a car and it has the image of a car on its outside surface. The advertiser is Davis-Rent-A-Car (a hypothetical company that specializes in renting cars to its customers). Applicant feels that having the advertisement message and source match the shape of the envelope strengthens the effect of the ad upon the customer. It makes the ad more impactful and it makes it more likely that the customer will remember the ad and act in accordance with the message of the ad (i.e., rent a car from Davis).

Optional Shapes

Envelope 10 (FIGS. 1-5) is in the shape of a car. It should be noted that other shaped envelopes are also possible. For example, FIG. 7 shows envelope 30 which is in the shape of a cell phone. The advertiser is the hypothetical cell phone company Dash.

In addition there is virtually a limitless amount of shapes that can be utilized for the envelopes. Some of these shapes include: a drink cup, a motorcycle, a house, and a soda can.

Coupons on Envelope

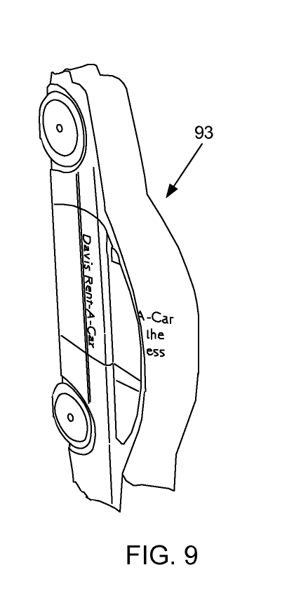

In another preferred embodiment redeemable coupon 35 is printed on the interior portion of envelope 10 (FIG. 8). By writing coupons, the restaurant is able to track the advertisement effectiveness of envelope 10. For example, when the coupon is redeemed the restaurant can record the redemption event and compile and analyze the data through scales and graphs. Further advertising efforts and coupon placements can be adjusted based on this analysis.

Sanitary Method of Money Exchange

It should be noted that it is inherent to the preferred embodiments that the present invention provides a sanitary method of returning change to the customer. For example, when the cashier places change into envelope 10 the customer is protected from touching the money inside the envelope. The customer can eat his food without ever handling the money inside envelope 10. This protects the customer from diseases and germs that may be on the money inside the envelope. This safety feature is especially valuable due to recent media focus on health and preventing unnecessary germ exposure.

Although the above-preferred embodiments have been described with specificity, persons skilled in this art will recognize that many changes to the specific embodiments disclosed above could be made without departing from the spirit of the invention. FIG. 9 shows another preferred embodiment of the present invention. In FIG. 9, envelope 93 is shaped similar to the envelope shown in FIGS. 3-5, except that the squared-off edges have been removed. Envelope 93 provides shape characteristics that more fully encompass the true profile shape of an automobile. In this manner the customer is even more fully impressed that he is grasping an object shaped like a car. As a result, the impact of the ad will have a greater effect on the customer. Also, it should be noted that envelopes 10 could be stored for easy accessibility in a dispenser at the cash register site. Therefore, the attached claims and their legal equivalents should determine the scope of the invention.

1-19. (canceled)

20. A method for transferring change including bills and coins from a cashier at a drive-thru window to a customer in an automobile, the method comprising:
the cashier placing the change in an envelope, the envelope having a pocket for holding the change and at least one ad printed on the envelope; and
the cashier passing the envelope through the drive-thru window to the customer.

21. The method of claim 20, wherein the at least one ad is paid for by a third party.

22. The method of claim 21, wherein the envelope comprises a shape that is associated with a business identity of the third party.

23. The method of claim 21, wherein the envelope comprises an image printed on the envelope that is associated with a business identity of the third party.

24. The method of claim 23, wherein the ad is printed on an outside surface of the envelope on top of the image.

25. The method of claim 20, wherein the envelope comprises a foldable envelope having an inside surface and an outside surface.

26. The method of claim 25, wherein the at least one ad comprises a plurality of ads.

27. The method of claim 26, wherein at least one ad is printed on the outside surface and at least ad is printed on the inside surface.

28. The method of claim 20, wherein a cost of at least one ad exceeds a cost of the envelope.

29. An envelope for transferring change including bills and coins from a cashier at a drive-thru window to a customer in an automobile, the envelope comprising:
a pocket for holding the change; and
at least one ad printed on the envelope, wherein the ad is paid for by a third party;
wherein the cashier places the change in the pocket and transfers the envelope through the drive-thru window to the customer.

30. The envelope of claim 29, wherein the envelope comprises a shape that is associated with the business identity of the third party

31. The envelope of claim 29, wherein the envelope comprises an image printed on the envelope that is associated with a business identity of the third party

32. The envelope of claim 31, wherein the ad is printed on an outside surface of the envelope on top of the image

33. The envelope of claim 29, wherein the envelope comprises a foldable envelope having an inside surface and an outside surface

34. The envelope of claim 33, wherein the at least one ad comprises a plurality of ads

35. The envelope of claim 29, wherein at least one ad is printed on the outside surface and at least one ad is printed on the inside surface.

36. The envelope of claim 29, wherein the ad is a coupon.

37. A method for transferring change including bills and coins from a cashier at a drive-thru window to a customer in an automobile, the method comprising:
the cashier placing the change in a foldable envelope, the envelope comprising:
an inside surface;
an outside surface;
a pocket for holding the change, the pocket attached to an inside surface of the foldable envelope, the pocket for holding the change;
at least one ad printed on the outside surface or the inside surface of the envelope, the at least one ad paid for by a third party;
shape characteristics associated with a business identity of the third party; and
an image printed on the outside surface of the envelope, wherein the image is associated with the business identity of the third party; and
the cashier passing the envelope through the drive-thru window to the customer.

38. The method of claim 37, wherein the at least one ad comprises a plurality of ads.

39. The method of claim 38, wherein at least one ad is printed on the outside surface and at least one ad is printed on the inside surface.
